(19) United States
(12) Patent Application Publication
(10) Pub. No.: US 2012/0179525 A1
(43) Pub. Date: Jul. 12, 2012

(54) ELECTRONIC COUPON DISTRIBUTION AND REDEMPTION VIA ACOUSTIC COMMUNICATION

(75) Inventors: Chad G. Seguin, Morgan Hill, CA (US); Byron E. Alsberg, San Jose, CA (US); Brett L. Paulson, Palo Alto, CA (US)

(73) Assignee: Naratte Inc., Sunnyvale, CA (US)

(21) Appl. No.: 13/163,094

(22) Filed: Jun. 17, 2011

Related U.S. Application Data
(60) Provisional application No. 61/430,702, filed on Jan. 7, 2011.

(51) Int. Cl. G06Q 30/00

(52) U.S. Cl. 705/14.16; 705/14.1; 705/14.39

(57) ABSTRACT

A computer-implemented method for redeeming an electronic coupon comprises receiving on a transmit device the electronic coupon that includes an embedded identifier that indexes coupon data; playing the identifier of the electronic coupon over air from a speaker of the transmit device in proximity to a receive device; decoding the identifier in response to the receive device receiving the audio signal over the air; and using the identifier to access the coupon data including purchase discount information.

### CROSS-REFERENCE TO RELATED APPLICATIONS

This application claims the benefit of priority to Provisional Patent Application 61/430,702 filed Jan. 7, 2011, entitled “COUPON DISTRIBUTION AND REDEMPTION VIA ACOUSTIC COMMUNICATION,” and is related to patent application Ser. No. 12/870,767, filed Aug. 27, 2010, entitled “SONIC COMMUNICATION SYSTEM AND METHOD;” and to patent application Ser. No. 13/151,516, filed Jun. 2, 2011, entitled “ACOUSTIC MODULATION PROTOCOL,” both incorporated herein by reference.

### BACKGROUND

With the proliferation of smart phone, the use and redemption of electronic coupons using the smart phones is becoming more widespread. One method of redeeming electronic coupons via smart phones is for a vendor to text a coupon to a user. When the user checkouts at a merchant establishment, the user simply shows the displayed coupon to the teller. Another method is to embed bar codes into the coupons, where upon checkout, the bar code is scanned and the coupon redeemed. One problem with the use of barcodes, however, is that smart phones may display the coupon at varying resolutions, making scanning of the barcodes from phones difficult and unreliable. In addition, with both methods, the merchants have no way of knowing where the coupon came from or whether users passed it on to others so the same coupons are used over and over. Finally, not all merchants are setup with barcode readers at point of sale terminals.

Accordingly, it would be desirable to provide an improved method and system for distributing and redeeming electronic coupons.

### BRIEF SUMMARY

A computer-implemented method for redeeming an electronic coupon comprises receiving on a transmit device the electronic coupon that includes an embedded identifier that indexes coupon data; playing the identifier of the electronic coupon over air from a speaker of the transmit device in proximity to a receive device; decoding the identifier in response to the receive device receiving the audio signal over the air; and using the identifier to access the coupon data including purchase discount information.

### BRIEF DESCRIPTION OF several views of THE DRAWINGS

FIG. 1 is a block diagram illustrating an exemplary acoustics system in which a process for electronic coupon distribution and redemption may be implemented.

FIG. 2 is a block diagram illustrating an exemplary electronic coupon redemption system.

FIG. 3 is a flow diagram illustrating a process for distributing and redeeming an electronic coupon in accordance with an exemplary embodiment.

FIG. 4 is block diagram illustrating a process for generating an electronic coupon having an embedded AMP ID.

### DETAILED DESCRIPTION

The exemplary embodiment relates to a method and system for distributing and redeeming electronic coupons via acoustic communication. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments provide methods and systems for distributing and redeeming electronic coupons. The exemplary embodiments associate a unique identifier with coupon data and use an acoustic modulation protocol to create an acoustically modulated identifier that can be decoded by an acoustic modulation protocol decoder. The modulated identifier is embedded into a multimedia file describing a coupon offer. The multimedia file with the embedded modulated identifier may be distributed to devices of end-uses as electronic coupons. The end user may redeem the electronic coupons during a transaction by playing the electronic coupon on their mobile devises, causing the modulated identifier to be transmitted over air to another device, such as a merchant terminal. The merchant terminal receives the modulated identifier by, for example, a microphone, and decodes the modulated identifier. The decoded identifier may then be used to perform various services, such as automatically applying a purchase discount, for example.

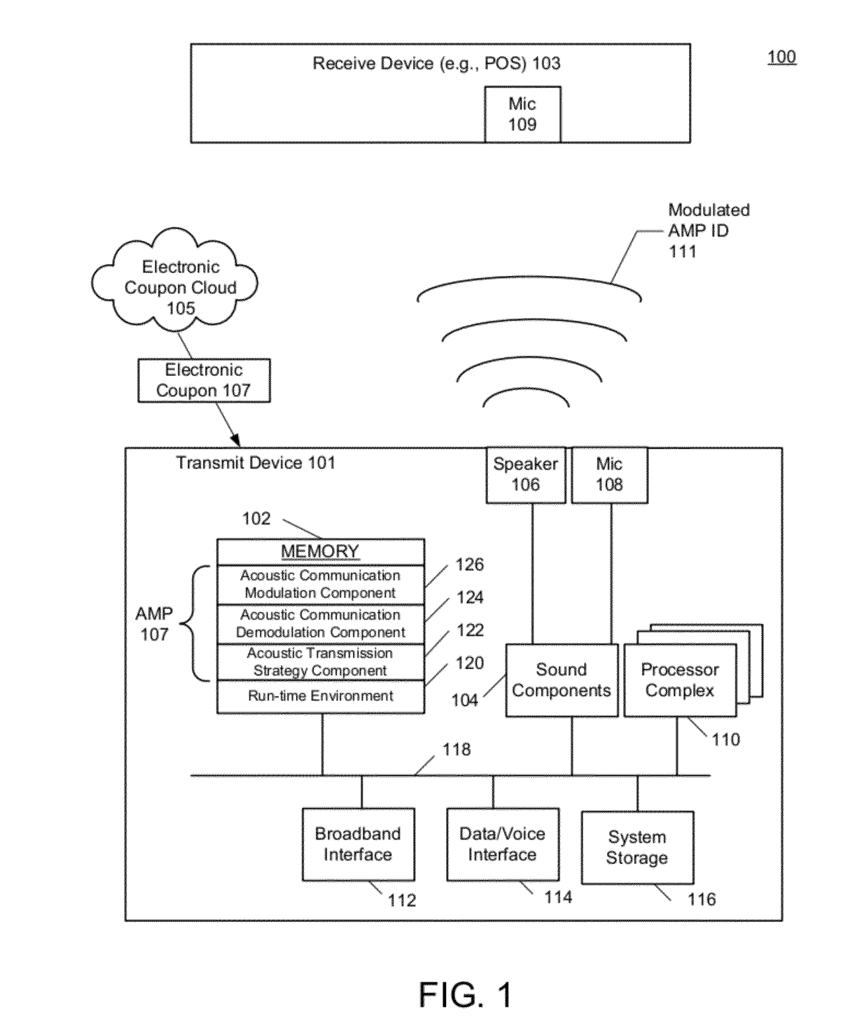

FIG. 1 is a block diagram illustrating an exemplary acoustics system in which a process for electronic coupon distribution and redemption may be implemented. The acoustics system 100 includes a transmit device 101, a receive device 103, and an electronic coupon distribution cloud 105. Transmit device 101 may include a memory 102, sound components 104 with speaker(s) 106 and/or microphone(s) 108, a processor complex 110, a broadband interface 112, data/voice interface 114 and system storage 116. Receive device 103 may include the same components, but the speaker may be optional. Transmit device 101 may be broadly referred to as a mobile device that includes electronic devices such as a smart phone, a feature phone, a laptop, a tablet, an e-reader, or a portable game system. In one embodiment, the receive device 103, and even the transmit device 101, may comprise any type of computer enabled device (i.e., point-of-sale terminals, electronic billboards, kiosks) or general-purpose computers capable of performing acoustic communication in accordance with the present invention.

According to the exemplary embodiment, the transmit device 101 and optionally the receive device 103 are enabled with an acoustic modulation protocol (AMP) 107. AMP 107 is an encoding/decoding process for transmitting data over the air using an audio signal from a speaker 106. Alternatively, AMP 107 may be referred to as an acoustic communication process. The AMP 107 may be used to embed any digital signal that is to be sent over an audio interface with data.

According to an exemplary embodiment, the digital signal is embedded with a coupon identifier, which in some embodiments is called an AMP ID, representing particular data. AMP 107 can encode the AMP ID into a modulated AMP ID 111. Inversely, at the receive device 103 AMP 107 can decode the modulated AMP ID 111 and recover the AMP ID, which can then be processed appropriately.

According to the exemplary embodiments, electronic coupon cloud 105 provides an electronic coupon 107 comprising a multimedia file that contains a modulated AMP ID 111, or will be embedded with an encoded AMP ID 111 using AMP 107. In one embodiment, electronic coupon cloud 105 comprises one or more servers that communicate via a network with the transmit device 101, and may generate as well as distribute the electronic coupon 107. In another embodiment, the electronic coupon 107 may be distributed by a third party.

Once received or accessed on the transmit device 101, the electronic coupon 107 can then be shared or redeemed. The electronic coupon may be shared by transmitting the electronic coupon 107 from the transmit device 101 to another device. The electronic coupon 107 may be redeemed by transmitting the modulated AMP ID 111 to an AMP-enabled device (e.g., receive device 103), where the modulated AMP ID 111 may be decoded and reconciled.

The acoustic modulation protocol (AMP) 107 may reside in memory 102 during run-time and may include an acoustic communication modulation component 126, an acoustic communication demodulation component 124, and an acoustic transmission strategy component 122. Acoustic communication modulation component 126, which may also be referred to as an encoder, includes functions and datasets that encode data, such as the AMP ID, and modulates the data over acoustic transmission frequencies, creating the modulated AMP ID 111 in accordance with the exemplary embodiment. Likewise, acoustic communication demodulation component 124 includes functions and datasets necessary to demodulate data from modulated acoustic carrier signals 111 received over various acoustic transmission frequencies in accordance with AMP. Acoustic transmission strategy component 122 includes functions and datasets necessary for identifying the acoustic transmission frequencies and timing to transmit and receive data acoustically in accordance with aspects of the present invention. For example, acoustic transmission strategy component 122 may identify the acoustic frequencies for transmitting data and to determine an optimal time for acoustically transmitting the data. The receive device 103 may include the same AMP components, with the exception of the acoustic transmission strategy component 122 in an embodiment where receive device 103 itself does not transmit a modulated AMP ID 111.

In the illustrative implementation in FIG. 1, memory 102 includes storage locations that are addressable by the processor complex 110 and adapters for storing software program code and data. For example, memory 102 may comprise a form of random access memory (RAM) that is generally classified as “volatile” memory. Processor complex 110 and various adapters may, in turn, comprise processing elements and logic circuitry configured to execute the software code and manipulate the data stored in the memory 102. Memory 102 may also include run-time environment 120 portions of which typically reside in memory and are executed by the processing elements. Run-time environment 120 may be based upon a general-purpose operating system, such as Linux, UNIX® or Windows®, the Apple OS® or any other general-purpose operating system. It may also be based upon more specialized operating systems such as the Blackberry Operating system from RIM, Inc., the Symbian OS from Nokia, Inc., the iPhone OS or iOS from Apple, Inc., the Android operating system from Google, Inc. of Mountain View Calif., the Web OS or HP Web OS from Hewlett Packard Co. or any other operating system designed for the mobile market place.

Sound components 104 include codecs and other components for converting sound transmitted through microphone 108 into a digital format such as PCM (pulsecode modulation). These codecs are also capable of converting the digital information back into an acoustic analog signal and then broadcasting through speaker 106.

Processor complex 110 may be a single processor, multiple processors or multiple processor cores on a single die. It is contemplated that processor complex 110 represents the one or more computational units available in transmit device 101. Processor complex 110 may also be a physical aggregation of multiple individual processors that each individually process and transfer data over interconnect 118. Alternate implementations of processor complex 110 may be a single processor having multiple on-chip cores that may partition and share certain resources also on the processor die such as L1L2 cache. For at least these reasons, aspects of the exemplary embodiment may be described as using a processor or multiple processors for convenience, however, it is contemplated that the term “processor” could also be applied to designs utilizing one core or multiple cores found on a single chip or die. Likewise, the term process is used to describe the act of executing a set of related instructions on one or several processors but it is also contemplated that alternate implementations could be performed using single or multiple threads executing the same or similar instructions on one or several processors each capable of multi-threaded execution.

Broadband interface 112 may be a WiFi, WiMAX or other connection to a network such as the Internet. The broadband interface 112 may also include wired connections to the Internet using CAT 5/6, Fiber Channel or similar methods. Data/voice interface 114 includes functions and datasets for transmitting data and voice over a wireless network. Protocols used for data/voice interface 114 may include one or more of GSM, CDMA, TDMA, FDMA or other wireless protocols. The data portions of data/voice interface 114 may carry data at 2G, 2.5G, 3G, 4G and beyond implemented using various wireless protocols including EDGE, EV-DO, HSPA, and others.

System storage 116 may be a form of non-volatile storage for storing a copy of run-time environment 120, applications and other data used by transmit device 101. System storage 116 may be on a removable SD (secure digital) storage or other similar device and that the SD storage may include security features for holding critical pieces of information such as credit card numbers and other similar information. Alternatively, system storage 116 may include conventional magnetic tapes or disks, optical disks such as CD-ROM, DVD, magneto optical (MO) storage or any other type of non-volatile storage devices suitable for storing large quantities of data. These latter storage device types may be accessed locally through a direct connection or remotely in the coupon cloud 105 or some other “cloud” through broadband interface 112 or data/voice interface 114 type network connections.

Moreover, various embodiments may include the same or similar components despite the particular implementation illustrated in FIG. 1. For example, some implementations may use a central interconnect 118 for communication among the components while other implementations may use multiple direct paths between each of the components. Alternate embodiments may combine one or more of these components into a single component or may separate them into different combinations of components. Functionality provided by the transmit device 101 and receive device 103 may be implemented in hardware, software or in various combinations thereof depending on the design and implementation details.

While examples and implementations have been described, they should not serve to limit any aspect of the exemplary embodiments. Accordingly, implementations of the exemplary embodiments can be implemented in digital electronic circuitry, or in computer hardware, firmware, software, or in combinations of them. Apparatus can be implemented in a computer program product tangibly embodied in a machine readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high level procedural or object oriented programming language, or in assembly or machine language if desired; and in any case, the language can be a compiled or interpreted language. Suitable processors include, by way of example, both general and special purpose microprocessors. Generally, a processor will receive instructions and data from a read only memory and/or a random access memory. Generally, a computer will include one or more mass storage devices for storing data files; such devices include magnetic disks, such as internal hard disks and removable disks; magneto optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto optical disks; and CD ROM disks. Any of the foregoing can be supplemented by, or incorporated in, ASICs.

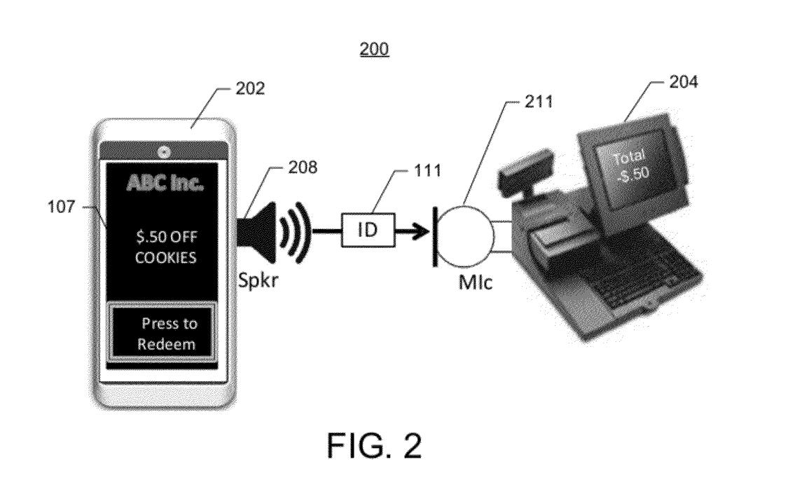

FIG. 2 is a block diagram illustrating an exemplary electronic coupon redemption system. In this specific system 200, the transmit device is represented as a smart phone 202, and the receive device is represented as a merchant or point-of-sale (POS) terminal 204. The smart phone 202 has access to the electronic coupon 107 and is communicating with the POS terminal 204 to redeem the electronic coupon 107 via acoustic communication. In one embodiment, the speaker 208 of the smart phone 202 transmits the modulated AMP ID 111 (along with any audio form the coupon multimedia file) to the POS terminal where the modulated AMP ID 111 is received using a microphone 212 and demodulated. In this embodiment, the system 200 facilitates payment transactions by transmitting the AMP ID from a user's smart phone 202 over a modulated acoustic carrier signal for the redemption of the electronic coupon 107 to automatically apply a discount (e.g. $0.50), resulting in a reduced purchase price.

Although the exemplary embodiment is being described in terms of the mobile device transmitting an modulated AMP ID 111 to a microphone 212 of a POS terminal 204, nothing prevents a reverse acoustic data communication where the POS terminal 204 includes a speaker that transmits a modulated acoustic carrier signal over air for receipt by a microphone of a mobile device, or an embodiment where the electronic coupon 107 information is transmitted between two mobile devices. In addition, the microphone of the POS terminal may be externally attached to the POS terminal, such as being implemented as part of a docking station for the transmit device for instance.

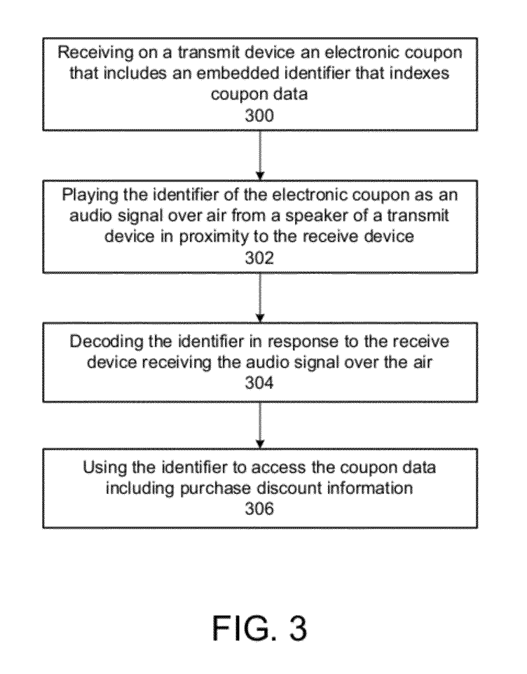

FIG. 3 is a flow diagram illustrating a process for distributing and redeeming an electronic coupon in accordance with an exemplary embodiment. The process may include receiving on a transmit device an electronic coupon that includes an embedded identifier that indexes coupon data (step 300). In the exemplary embodiment, the identifier (ID) may comprise an AMP ID that can be used to index coupon data. The electronic coupon 107 may either be generated by the electronic coupon cloud 105, an issuer of the electronic coupon, or by a vendor or merchant of a service or merchandise, and then sent to a user's transmit device 101, or created on the user's transmit device 101 when instructed to do so.

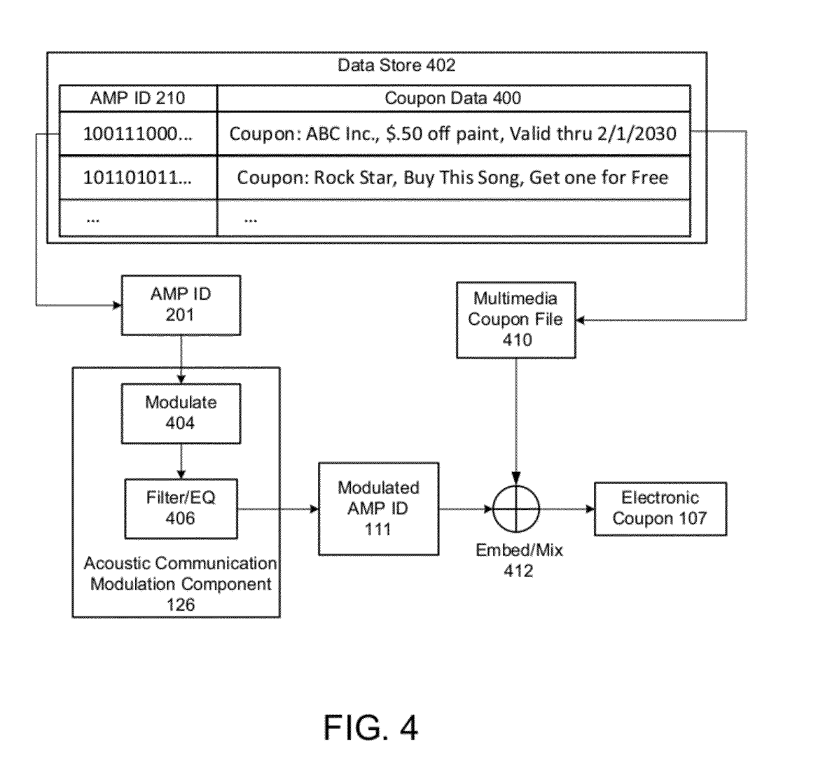

FIG. 4 is block diagram illustrating a process for generating an electronic coupon having an embedded AMP ID 210. The process for generating the electronic coupon 107 may begin by creating an AMP ID 210 and associating the AMP ID 210 with data representing coupon data 400, such as the purchase discount. In one embodiment, the AMP ID 210 comprises a number or alphanumeric string that is unique for each electronic coupon 107. The AMP ID 210 can be as unique as needed, e.g., unique to a particular electronic coupon 107, unique to the coupon issuer, unique to a particular account or user, or unique as a pointer to an independent entity such a video, or website.

The AMP ID and the coupon data 400 may be associated and stored in a data store 402. In one embodiment, the data store 402 may be maintained and/or accessed by the electronic coupon cloud 105 (FIG. 1). In one embodiment, the coupon data 400 comprises at least a portion of: an identity an issuer of the electronic coupon, e.g., “ABC Inc.”, a discount amount, e.g., “$0.50, and an expiration date. In a further embodiment, the coupon data 400 associated with the AMP ID 210 may also identify a set of users and/or transmitting devices to which the electronic coupon 107 is distributed.

In one embodiment, the AMP ID 210 may be used to index the data store and look up the associated coupon data 400 during redemption of the electronic coupon 107. In another embodiment, the AMP ID 210 may be configured to also include information comprising the coupon data 400, such as the discount amount, the expiration date and an ID of the coupon issuer. As the AMP ID is an index into a set of coupon data, the AMP ID can represent countless data associations including the issuer, the merchant, the discount or incentive, the person obtaining the electronic coupon 107 and their purchasing history, and the date of expiration.

To generate the electronic coupon 107, an AMP ID 210 associated with the coupon data 400 for the electronic coupon may be retrieved from the data store 402 and input to the acoustic communication modulation component 126 of AMP. The acoustic communication modulation component 126 may use a binary form of the AMP ID 210 to modulate 404 one or more selected frequencies for one or more acoustic carrier signals, creating a modulated AMP ID 111. In an optional embodiment, the modulated AMP ID 111 may also be filtered/equalized 406. In one embodiment, the modulated AMP ID 111 may be filtered to remove any unintended audible harmonics created during modulation. The modulated AMP ID 111 may also be equalized to pre-compensate for known degradations that will occur further along a signal path. The output of the acoustic communication modulation component 126 is a frequency modulated audio representation of the AMP ID 111.

The modulated AMP ID 111 is then embedded/mixed 412 into a multimedia coupon file 410 that contains at least a portion of the content of the coupon data 400 to create the electronic coupon 107. The multimedia coupon file 410 may comprise audio, video, text or a combination thereof. However, once the multimedia coupon file 410 is modified to contain the modulated AMP ID 111, the multimedia coupon file 410 becomes the electronic coupon 107. Since the modulated AMP ID 111 audio, the modulated AMP ID 111 can be embedded into both audio and video file formats including: AAC, AIF, IFF, M3U, MID, MP3, MPA, RA, WAV, WMA, 3G2, 3GP, ASF, ASX, AVI, FLV, MOV, M4V, MP4, MPG, PCM, RM, SWF, VB and WMV. As used herein, the terms embedding and mixing the AMP ID into the multimedia file also comprises embodiments where the AMP ID is associated with multimedia file and transmitted separately.

In one embodiment, the acoustic communication modulation component 126 may include a mixer for embedding the AMP ID in the multimedia coupon file 410. In another embodiment, the mixer may be a separate component from the acoustic communication modulation component 126. The mixer may include a band pass filter to ensure that the modulated AMP ID 111 is not polluted with audio artifacts.

After electronic coupon generation, the electronic coupon 107 is ready for distribution to one or more user devices for redemption and/or sharing. In another embodiment, the embedding/mixing step may be performed by the transmit device prior to playing of the electronic coupon 107, rather than during coupon generation.

In one embodiment, the electronic coupon cloud 105 generates and distributes the electronic coupons. In another embodiment, electronic coupons generated by the electronic coupon cloud 105 may be distributed to the transmit device 101 by third parties, such as a coupon issuer or merchant. In yet another embodiment, the third parties may both generate and distribute the electronic coupons.

The electronic coupon 107 can be delivered to the device by any means data is delivered to a device (wired and wireless), including audio, USB, Firewire, cellular (data channel, MMS, etc.), WiFi, BlueTooth, proprietary wireless, transducers, memory devices including SD cards, video, proprietary data interfaces and push button.

In one embodiment, the electronic coupon 107 may be distributed directly to the transmit device 101 and stored on the transmit device. Examples of automatic direct distribution methods include as email, text message, and data channel. The electronic coupon 107 can be pushed over a data channel to the device, or software on the device can poll a remote server to pull a electronic coupon 107.

An electronic coupon 107 can be triggered for direct distribution by numerous means including proximity identification, user request, and analytics. In one embodiment, the electronic coupon 107 may be sent to the transmit device 101 via proximity identification. Proximity Identification is the concept of a user walking into a designated area and triggering the automatic sending of the electronic coupon 107 to the transmit device 101, such as from the electronic coupon cloud 105, for example. The proximity trigger could be a range of technologies including GPS/location tracking, BlueTooth signal fields, WiFi signal fields, cellular signal fields, proprietary wireless fields, sound fields, magnetic fields, video/picture/landmark identifiers, sensor identifiers (such as heat signature mapping), or a direct data connection.

In one embodiment, the electronic coupon 107 may be sent to the transmit device 101 via manual trigger (e.g., a user manually requesting one after seeing an advertisement or other message). The user can manually request the electronic coupon 107 by a number of means including fax, phone, email, SMS, MMS, IM, website entry, FTP, or requesting in person.

In one embodiment, the electronic coupon 107 may be distributed to the transmit device 101 via customer analytics. That is a server may access a contact database, analyze customer buying behavior and automatically deliver relevant electronic coupons 107 based on recurring dates, shopping seasons or targeted merchandise, for example.

In one embodiment, the electronic coupon 107 may be distributed indirectly to the transmit device 101 by the user downloading the electronic coupon 107 onto a PC or other device and then transferring the electronic coupon 107 to the transmit device 101.

In a further embodiment, the electronic coupon 107 may be indirectly distributed to the transmit device by a server sending a message (e.g., email or text) having a link directed to a webpage for the electronic coupon 107. In this embodiment, the electronic coupon 107 is stored remote from the transmit device 101 and the embedded AMP ID may be played through a browser or media player on the transmit device 101 from a remote source.

In yet a further embodiment, receiving the electronic coupon 107 on the transmit device 101 further includes a user of the transmit device 101 navigating a browser or media player to a website where the electronic coupon 107 is displayed and playing the electronic coupon 107 directly from the webpage. In this embodiment, the identifier is played from the website along with any audio from the electronic coupon 107 via the speaker of the transmit device 101. In this embodiment, the electronic coupon 101 need not be distributed to the transmit device 101.

Referring again to FIG. 3, in relation to a purchase transaction with a merchant, the identifier is played as an audio signal over air from a speaker of a transmit device in proximity to a receive device (step 302). In one embodiment, electronic coupons 107 may comprise one of several types: no mixed media; mixed text media; mixed audio media; mixed text and audio media, mixed video media and mixed text and video media. For example, the electronic coupon 107 could be as simple as an audio-only MP3 file with an embedded identifier, such as the modulated AMP ID 111. In the embodiment where the electronic coupon 107 comprises mixed video and/or text, the transmit device 101 may display the video/text portion of the electronic coupon 107 on a display screen while the modulated AMP ID 111 is played over the speaker 106. The electronic coupon 107 can also be a streaming video file and redeemed while streaming and playing in real time. The modulated AMP ID 111 may be transmitted at an inaudible frequency (e.g., >20 kHz), or at an audible frequency (e.g., <20 kHz).

In the embodiment where the electronic coupon 107 is distributed directly to the transmit device 101 such as through text messaging, e-mail, or file download, the AMP ID 201 is played from a source on the transmit device 101. However, in the embodiment where the electronic coupon 107 is distributed to the transmit device 101 via an e-mail link to a website (e.g., electronic coupon cloud 105), the AMP ID 201 is played by a browser or media player from a source remote from the transmit device 101.

In response to the receive device 103, such as a merchant terminal, receiving the audio signal over the air, the identifier is decoded (step 304). In one embodiment, the identifier can be decoded on the receive device 103 that is configured with the acoustic communication demodulation component 124 of AMP 107 (FIG. 1). In another embodiment, the receive device 103 may transmit the identifier to a remote location for decoding of the identifier.

The decoded identifier is then used to access coupon data, including purchase discount information (step 306). The coupon data can be accessed locally or remotely. In one embodiment where the identifier comprises at least a portion of the coupon data, such as the discount amount, the receive device 103 locally accesses the discount amount from the identifier and can be configured to automatically subtract the discount amount from the purchase price of the transaction. In another embodiment, the receive device 103 can send the identifier to a server to access data stored remotely to perform various services such as other financial transactions, file sharing, or information exchange. For example, with respect to FIG. 4, the identifier (e.g., AMP ID 210) could be used to access the data store 402 and retrieve the coupon data 400 associated with the AMP ID 210.

Enhancements

Electronic Coupon Sharing

In a further aspect of the exemplary embodiment, the system 100 enables a user of the transmit device 101 to share the electronic coupon 107 with another user. In this embodiment, after generating an electronic coupon 107 with a unique identifier, the electronic coupon cloud may log the electronic coupon information in an account for user A and electronic coupon to user A's transmit device. User A then shares the electronic coupon 107 with another user, user B, by sending the electronic coupon 107 from user A's transmit device to user B's transmit device. User B's transmit device extracts the identifier from the electronic coupon 107 and sends the identifier the electronic coupon cloud 105. The electronic coupon cloud 105 generates a copy of the electron coupon and embeds a new identifier. The electronic coupon cloud then logs the new electronic coupon information including the new identifier in the account for user B.

Leveraging the traceability of an electronic coupon 107, the issuer or merchant of the electronic coupon 107 can incentivize consumers or distributors to share their electronic coupon 107 with other consumers. An incentive plan can be executed by tracking the number of electronic coupon 107 the user shares and/or shared electronic coupon 107 that are redeemed by other users.

According to the exemplary embodiment, the electronic coupon incentive program may reward users based on the number of coupon shares and redemptions and may operate as follows. After the creation of the shared electronic coupon for User B, the electronic coupon cloud 105 credits user A's account for a share and logs user B's identifier. In response to user B redeeming the new electronic coupon, the electronic coupon cloud 105 credits user A's account with a redemption. In response to user B sharing the new electronic coupon with user C, the electronic coupon cloud 105 credits user A and B's accounts with a share. In response to user B redeeming the new electronic coupon, the electronic coupon cloud 105 credits user A and B's account with a redemption, and so on. Based on the number of shares and redemptions, users may be offered rewards such as discount or free merchandise or services.

Transmission Of The Electronic Coupon Identifier Via Alternate Mediums

According to a further aspect of the exemplary embodiment, the electronic coupon identifier may be transmitted via alternate mediums, rather than over an acoustic air communication. The transmit device 101 may decode the modulated identifier in the electronic coupon 107 to recover the identifier, transcode the recovered identifier for a selected medium, and then re-transmit the transcoded identifier through other mediums including Near Field Communication (NFC), Ultra Wide-band (UWB), Radio Frequency Identification (RFID), Infrared, WiFi, BlueTooth, proprietary wireless, Bar code/Display technology, USB, Firewire, wired, HTTP or any medium which devices communicate to each other. The receive device 103 receives the transmitted identifier via the alternative medium and processes the transaction as it would have over an acoustic medium.

Benefits of electronic coupon

No specialized hardware (NFC, GPS, BT, chips, tags, dongles, etc.) is needed to communicate via AMP besides a microphone and a speaker, which are found on most computers and portable devices. This means electronic coupons 107 can be submitted and redeemed by a broad range of devices including (but not limited to) feature phones, smart phones, tablets, portable music devices, personal computers and POS systems with little to no increase in the cost footprint of an existing system.

Since AMP technology operates via audio this means the electronic coupon 107 can take numerous forms and file formats. The electronic coupon 107 could be as complex as a high definition video with an AMP ID embedded inside of it or as basic as a MP3 file that can be played by any audio player, even one without a screen. This enables the issuer to select from a broad array of coupon experiences for different types of devices, consumers and industries.

Since an electronic coupon 107 is multimedia, the issuer or merchant can brand their coupon experience with audio jingles or videos that potentially second as commercials. This new coupon experience could be a tool to further market to the customer and build brand loyalty.

Since AMP is software, the electronic coupon 107 redemption process can be as passive as the user redeeming the electronic coupon 107 with no interaction with the device or as active as a user texting or emailing to receive a electronic coupon 107 and having to press a button on the electronic coupon 107 during the redemption process. This flexibility provides the issuer with many options for its coupon distribution and redemption strategy.

Since the electronic coupon 107 could be a file, it can be stored on the user's device, and the user can hold as many electronic coupons 107 as the device memory can hold, or user cloud account storage may allow much more than the number of non electronic or paper coupons one could practically carry. This enables the transmit device to act a user's electronic wallet, alleviating the user from having to carry a multiplicity of paper coupons to obtain incentivized discounts.

Since the electronic coupon 107 is digital, its expiration deadline can be more tightly controlled than a paper coupon. This allows issuers to create coupons real time that expire in a short amount of time to incentivize the user to make an impulse purchase or enter a store.

Since the AMP ID may be an index to a given digital data set the electronic coupon 107 can dynamically change whereas a paper coupon is static. This allows issuers to update deals real time, including cancelling or extending incentives.

Since a electronic coupon 107 is digital, it does not require the use of paper for redemption and has a much lower cost and environmental impact. This enables issuers to create more coupons and extend more incentives, while lowering their cost footprint across their coupon system and being able to sell a green feature.

Since a electronic coupon 107 is digital, a electronic coupon 107 index can refer to a user profile and preferences. This provides analytical data to the issuer and/or the merchant that can help them determine what incentives are successful, what are the buying preferences of a person or demographic, how best to incentivize a person or demographic and how successful a marketing campaign is.

A method and system for a method and system for distributing and redeeming electronic coupons via acoustic communication has been disclosed. The present invention has been described in accordance with the embodiments shown, and there could be variations to the embodiments, and any variations would be within the spirit and scope of the present invention. Accordingly, many modifications may be made by one of ordinary skill in the art without departing from the spirit and scope of the appended claims.

We claim:

1. A computer-implemented method for redeeming an electronic coupon, comprising:
receiving on a transmit device the electronic coupon that includes an embedded identifier that indexes coupon data;
playing the identifier of the electronic coupon over air from a speaker of the transmit device in proximity to a receive device;
decoding the identifier in response to the receive device receiving the audio signal over the air; and
using the identifier to access the coupon data including purchase discount information.

2. The method of claim 1 further comprising: generating by an electronic coupon cloud the electronic coupon for distribution to the transmit device.

3. The method of claim 1 wherein the identifier comprises an acoustic modulated communication identifier (AMP ID).

4. The method of claim 3 further comprising:
creating the AMP ID and associating the AMP ID with data representing coupon data, including the purchase discount.

5. The method of claim 4 wherein the AMP ID comprises a number or alphanumeric string that is unique for each electronic coupon.

6. The method of claim 4 wherein the coupon data comprises at least a portion of:
an identity an issuer of the electronic coupon; a discount amount; an expiration date;
and an identity of users to which the electronic coupon is distributed.

7. The method of claim 4 further comprising using the AMP ID to modulate one or more selected frequencies for one or more acoustic carrier signals, creating a modulated AMP ID.

8. The method of claim 7 further comprising at least one of embedding and mixing the modulated AMP ID into a multimedia file that contains at least a portion of content comprising the coupon data to create the electronic coupon.

9. The method of claim 1 further comprising triggering direct distribution of the electronic coupon to the transmit device by at least one of proximity identification, user request, and analytics.

10. The method of claim 1 further comprising indirectly distributing the electronic coupon to the transmit device by a server sending a message to the transmit device having a link directed to a webpage for the electronic coupon, wherein the identifier is played on the transmit device from a remote source.

11. The method of claim 1 wherein using the identifier to access the coupon data including purchase discount information further comprises the receive device locally accessing the discount amount and automatically subtracting the discount amount from a purchase price of a transaction.

12. The method of claim 1 wherein using the identifier to access the coupon data including purchase discount information further comprises the receive device sending the identifier to a server to access data stored remotely.

13. The method of claim 1 further comprising enabling a user of the transmit device to share the electronic coupon with another user.

14. A system, comprising:
a transmit device having a processor, memory and a speaker, the processor configured to:
receive on a transmit device an electronic coupon that includes an embedded identifier that indexes coupon data, and
play the identifier of the electronic coupon over air from a speaker of the transmit device in proximity to the receive device; and
a receive device having a microphone that is configured to;
receive the audio signal over the air and decode the identifier, and use the identifier to access the coupon data including purchase discount information.

15. The system of claim 14 further comprising an electronic coupon cloud in communication with the transmit device that generates the electronic coupon for distribution to the transmit device.

16. The system of claim 14 wherein the identifier comprises an acoustic modulated communication identifier (AMP ID).

17. The system of claim 16 further comprising:
creating the AMP ID and associating the AMP ID with data representing coupon data, including the purchase discount.

18. The system of claim 17 wherein the AMP ID comprises a number or alphanumeric string that is unique for each electronic coupon.

19. The system of claim 17 wherein the coupon data comprises at least a portion of:
an identity an issuer of the electronic coupon; a discount amount; an expiration date;
and an identity of users to which the electronic coupon is distributed.

20. The system of claim 17 wherein the AMP ID is used to modulate one or more selected frequencies for one or more acoustic carrier signals, creating a modulated AMP ID.

21. The system of claim 20 wherein the modulated AMP ID is at least one of embedded and mixed into a multimedia file that contains at least a portion of content comprising the coupon data to create the electronic coupon.

22. The system of claim 14 wherein direct distribution of the electronic coupon is triggered to the transmit device by at least one of proximity identification, user request, and analytics.

23. The system of claim 14 wherein the electronic coupon is indirectly distributed to the transmit device by a server sending a message to the transmit device having a link directed to a webpage for the electronic coupon, wherein the identifier is played on the transmit device from a remote source.

24. The system of claim 14 wherein the received device uses the identifier to access the coupon data including purchase discount information further comprises the receive device locally accessing the discount amount and automatically subtracting the discount amount from a purchase price of a transaction.

25. The system of claim 14 wherein the received device uses the identifier to access the coupon data including purchase discount information further comprises the receive device sending the identifier to a server to access data stored remotely.

26. The system of claim 14 wherein a user of the transmit device is enabled to share the electronic coupon with another user.

27. A computer-implemented method for redeeming an electronic coupon, comprising:
receiving on a transmit device the electronic coupon that includes an embedded modulated identifier that indexes coupon data;
decoding the modulated identifier in the electronic coupon to recover the identifier;
transcoding the recovered identifier for a selected medium;
re-transmitting the transcoded identifier in proximity to a receive device; and
using by the receive device the transcoded identifier to access the coupon data including purchase discount information.

28. The method of claim 27 wherein the selected medium comprises one of Near Field Communication (NFC), Ultra Wide-band (UWB), Radio Frequency Identification (RFD), Infrared, WiFi, BlueTooth, proprietary wireless, Bar code/Display technology, USB, Firewire, wired, and HTTP.

29. A method for generating, distributing and sharing an electronic coupon, wherein a server in an electronic coupon cloud is in communication with transmit devices of various users, comprising:
generating by the electronic coupon cloud an electronic coupon with a unique identifier;
logging information for the electronic coupon in an account for user A and sending the electronic coupon to user A's transmit device;
sending the electronic coupon from user A's transmit device to user B's transmit device, thereby sharing the electronic coupon;
extracting by user B's transmit device the identifier from the electronic coupon and sending the identifier to the electronic coupon cloud;
generating by electronic coupon cloud a copy of the electron coupon and embedding a new identifier; and
logging information for the copy of electronic coupon including the new identifier in an account for user B.

30. The method of claim 29 further comprising rewarding users based on a number of coupon shares and redemptions by:
crediting by the electronic coupon cloud user A's account for sharing the electronic coupon and logging user B's identifier;
in response to user B redeeming the copy of the electronic coupon, crediting by the electronic coupon cloud user A's account with a redemption;
in response to user B sharing the copy of the electronic coupon with user C, crediting by the electronic coupon cloud user A's account and user B's account with a share; and
in response to user B redeeming the copy of the electronic coupon, crediting by the electronic coupon cloud user A's account and user B's account with a redemption.
